(19) United States
(12) Patent Application Publication
(10) Pub. No.: US 2012/0163000 A1
(43) Pub. Date: Jun. 28, 2012

(54) COVER MEMBER MOUNTING DEVICE, BASE-ATTACHED LAMP, AND LIGHTING FIXTURE

(75) Inventor: Kenji NEZU, Kanagawa-ken (JP)

(73) Assignee: TOSHIBA LIGHTING & TECHNOLOGY CORPORATION, Kanagawa (JP)

(21) Appl. No.: 13/315,588

(22) Filed: Dec. 9, 2011

(30) Foreign Application Priority Data
Dec. 10, 2010 (JP) 2010-275856
Dec. 10, 2010 (JP) 2010-275857

(51) Int. Cl. F21V 21/02; F16B 7/18

(52) U.S. Cl. 362/368; 403/300

(57) ABSTRACT

A cover member mounting device includes a cover member that forms a shape having an opening in one end and has a screw portion formed near the opening. A body has an opening portion formed at the side of one end, and has a body-side screw portion screwed into the screw portion of the cover member and formed near the opening portion. An elastic member is interposed between the opening of the cover member and the opening portion of the body. A rotation stopping member has an engagement portion, and an engagement receiving portion formed to face the screw portion of the cover member or the body-side screw portion of the body. The engagement portion and the engagement receiving portion are engaged by the reactive force generated when the elastic member is deformed by screwing the cover member into the body.

### CROSS-REFERENCE TO RELATED APPLICATIONS

This application is based upon and claims the benefit of priority from the prior Japanese Patent Application No. 2010-275856, filed on Dec. 10, 2010, the entire contents of which are incorporated herein by reference. Further this application is based upon and claims the benefit of priority from the prior Japanese Patent Application No. 2010-275857, filed on Dec. 10, 2010, the entire contents of which are incorporated herein by reference.

### FIELD

Embodiments described herein generally relate to a cover member mounting device, a base-attached lamp, and a lighting fixture.

### BACKGROUND

In recent years, as a light source of various lighting fixtures, in place of a filament lamp, a base-attached lamp such as a bulb-type LED lamp has been adopted which uses a light emitting diode, i.e. a solid-state light emitting element being advantageous in terms of a long lifespan and low power consumption. In particular, most recently, a beam-type base-attached lamp called a beam lamp that can substitute for an existing reflective incandescent lamp is commercialized.

Since this kind of beam-type base-attached lamp is suitable for the spotlight of a store or the floodlighting of a building and a signboard, the base-attached lamp is widely used outdoors. Therefore, it is required to save energy, increase the lifespan, and improve workability at the time of assembling.

In addition, it is required to secure a watertight property with respect to a light emitting unit composed of a light emitting diode and improve reliability.

### BRIEF DESCRIPTION OF THE DRAWINGS

FIGS. 1A and 1B are diagrams illustrating a cover member mounting device according to an embodiment of the invention, where FIG. 1A is a cross-sectional view illustrating a partially notched portion Of a cover member, in a state in which the cover member is screwed into a body and FIG. 1B is a cross-sectional view illustrating a partially notched portion of the cover member, in a state in which the cover member is fixed to the body;

FIGS. 2A to 2C are diagrams illustrating the cover member, where FIG. 2A is a perspective view of the covet member when viewed from the lower side, FIG. 2B is an enlarged cross-sectional view of a b portion in FIG. 2A, and FIG. 2C is an enlarged cross-sectional view of a c portion in FIG. 2A;

FIGS. 3A and 3B are diagrams illustrating a body, where FIG. 3A is a perspective view of the body when viewed from the upper side and FIG. 3B is a side view of the body;

FIGS. 4A and 4B are diagrams illustrating the body, where FIG. 4A is an enlarged cross-sectional view of an a portion in FIG. 3B and FIG. 4B is an enlarged cross-sectional view of a b portion in FIG. 3B;

FIGS. 5A to 5F are diagrams illustrating a rotation stopping member, where FIG. 5A is a partial side view illustrating a state before the rotation stopping member is engaged, FIG. 5B is a partial side View illustrating a state immediately before the rotation stopping member is engaged, FIG. 5C is a partial side view illustrating a state in which the rotation stopping member is engaged, FIG. 5D is a partial side view illustrating a state before the rotation stopping member is engaged, in a first modification of the rotation stopping member, FIG. 5E is a partial side view illustrating a state in which the rotation stopping member is engaged, in the first modification of the rotation stopping member, and FIG. 5F is a partial side view illustrating a second modification of the rotation stopping member;

FIG. 6 is a cross-sectional perspective view illustrating a base-attached lamp that has the cover member mounting device according to the embodiment of the invention;

FIGS. 7A and 7B are enlarged views of an A portion of FIG. 6 in the base-attached lamp, where FIG. 7A is a cross-sectional view illustrating a partially notched portion of the cover member, in a state in which the cover member is screwed into the body and FIG. 7B is a cross-sectional view illustrating a partially notched portion of the cover member, in a state in which the cover member is fixed to the body;

FIG. 8 is an exploded perspective view of the base-attached lamp;

FIG. 9 is a cross-sectional view schematically illustrating a lighting fixture that uses the base-attached lamp as a light source;

FIGS. 10A and 10B are diagrams illustrating the cover member mounting device according to the embodiment of the invention, where FIG. 10A is a cross-sectional perspective view illustrating a partially notched portion and FIG. 10B is an enlarged cross-sectional view of an A portion of FIG. 10A;

FIG. 11 is a cross-sectional perspective view illustrating a base-attached lamp that has the cover member mounting device according to the embodiment of the invention;

FIG. 12 is a diagram illustrating the base-attached lamp and is an enlarged cross-sectional view of an A portion of FIG. 11; and

FIG. 13 is an exploded perspective view of the base-attached lamp.

### DETAILED DESCRIPTION

In view of the above circumstances, an aspect of embodiments provides a cover member mounting device. The cover member mounting device includes a cover member that forms a shape having an opening in one end and has a screw portion formed near the opening; a body that has an opening portion formed at the side of one end and has a body-side screw portion screwed into the screw portion of the cover member and formed near the opening portion; an elastic member that is interposed between the opening of the cover member and the opening portion of the body; and a rotation stopping member that has an engagement portion and an engagement receiving portion formed to face at least one of the screw portion of the cover member and the body-side screw portion Of the body, wherein the engagement portion and the engagement receiving portion of the rotation stopping member are engaged by the reactive force generated when the elastic member is deformed by screwing the cover member into the body.

According to an aspect of embodiments, a cover member mounting device, a base-attached lamp having the cover member mounting device, and a lighting fixture that can improve workability can be provided.

In view of the above circumstances, other aspect of the embodiments provides a base-attached lamp. The base-attached lamp includes a cover member that has an opening in one end, has a screw portion formed near the opening, has a cover-side step portion continuous to the screw portion and leading to an opening end, and has a light transmitting property; a body that has an opening portion formed at the side of one end, a body-side screw portion screwed into the screw portion of the cover member and formed near the opening portion, and a body-side step portion formed to be continuous to the body-side screw portion and face the cover-side step portion; a packing that is disposed in a space portion that is formed by making the cover-side step portion and the body-side step portion face each other and has a cross-section to be approximately rectangular; a light emitting unit that is disposed in the body to face the cover member; and a base member that is provided at the side of the other end of the body, wherein the packing is compressed by each inner wall of the space portion by screwing the cover member into the body.

According to other aspect of embodiments, a cover member mounting device, a base-attached lamp having the cover member mounting device, and a lighting fixture that can secure a watertight function in a mounting portion of a cover member and a body can be provided.

Hereinafter, an embodiment of a cover member mounting device, a base-attached lamp, and a lighting fixture according to the invention will be described.

### First Embodiment

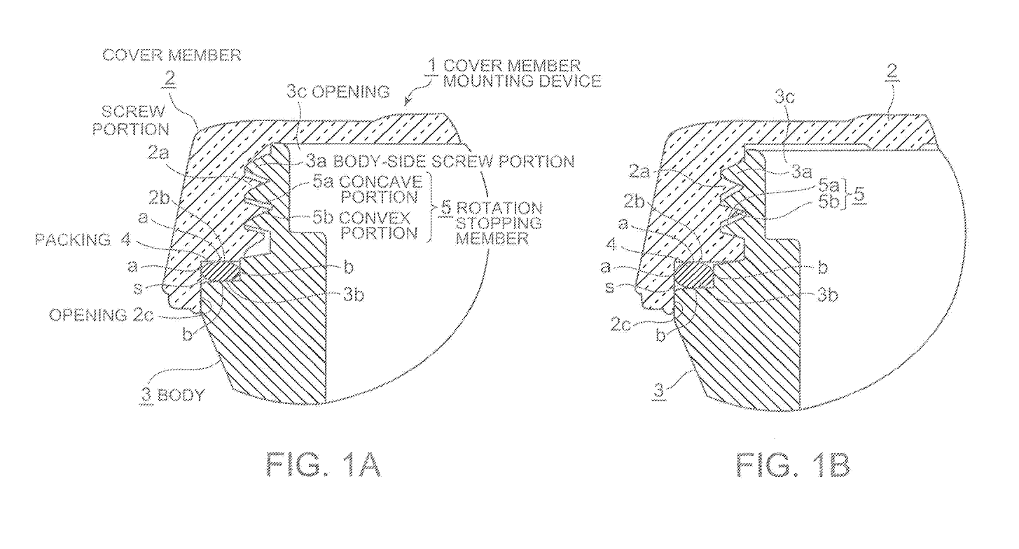

First, the cover member mounting device will be described. In this embodiment, the cover member mounting device that is used in a beam-type base-attached lamp is configured. As illustrated in FIGS. 1A and 1B, a cover member mounting device 1 includes a cover member 2 where a screw portion 2a is formed in an inner circumferential surface of an opening 2c, a body 3 where a body-side screw portion 3a screwed into the screw portion 2a of the cover member 2 is formed in an outer circumferential surface of an opening 3c, a packing 4 that is interposed between the opening 2c of the cover member and the opening 3c of the body, and a rotation stopping member 5 that includes a concave portion 5a and a convex portion 5b formed to face an O ring in this embodiment and at least one of the screw portion 2a of the cover member 2 and the body-side screw portion 3a of the body 3, respectively.

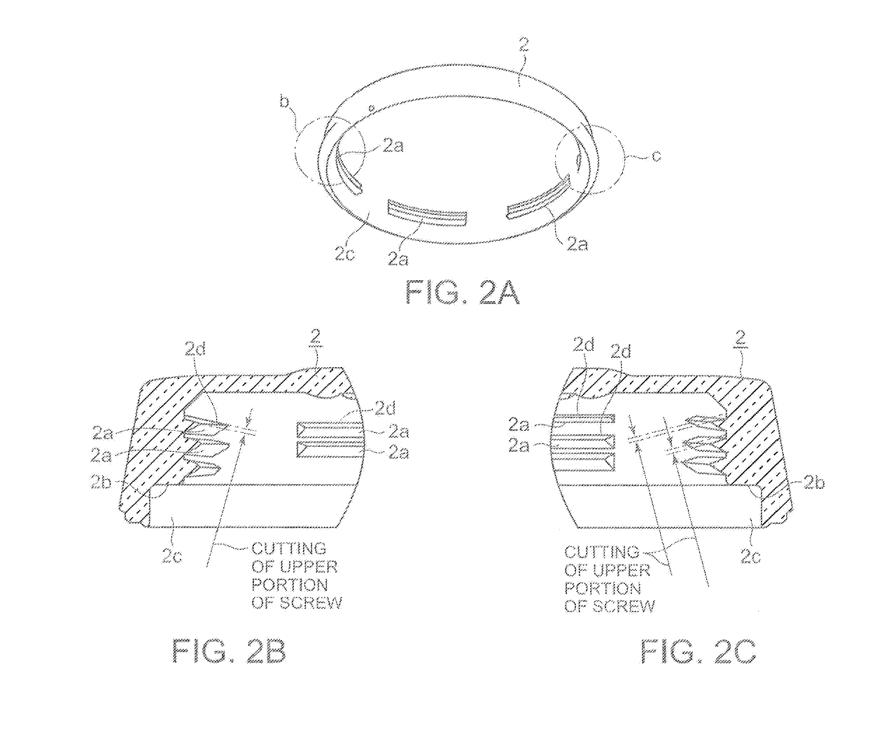

As illustrated in FIGS. 2A to 2c, the cover member 2 is made of synthetic resin or metal. In this embodiment, in order to constitute a globe of the base-attached lamp, the cover member 2 forms a circular tray shape having the opening 2c in one end with transparent acrylic resin, integrally forms the screw portion 2a in the inner circumferential surface of the opening, and integrally forms an annular step portion 2b that is continuous to the screw portion 2a and leads to an opening end of the opening 2c.

In this embodiment, the screw portion 2a includes two screws and is provided with 6 screw portions having the predetermined width at an equivalent interval of 60° in a radial direction from the center of a circle (refer to FIG. 2A). The 6 screw portions 2a are formed such that spirals of screw threads constituting the screws are continues as the two screws. In addition, top surfaces of the screw threads after the first thread (the uppermost portion is the first thread in FIGS. 2A to 2C) in the screw threads are cut and concave portions 2d are formed.

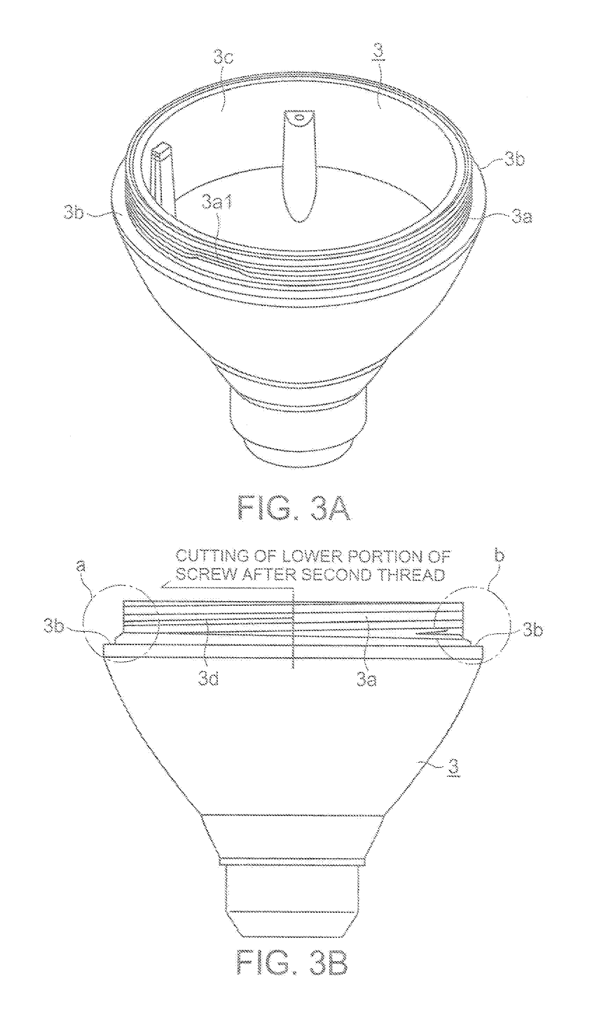

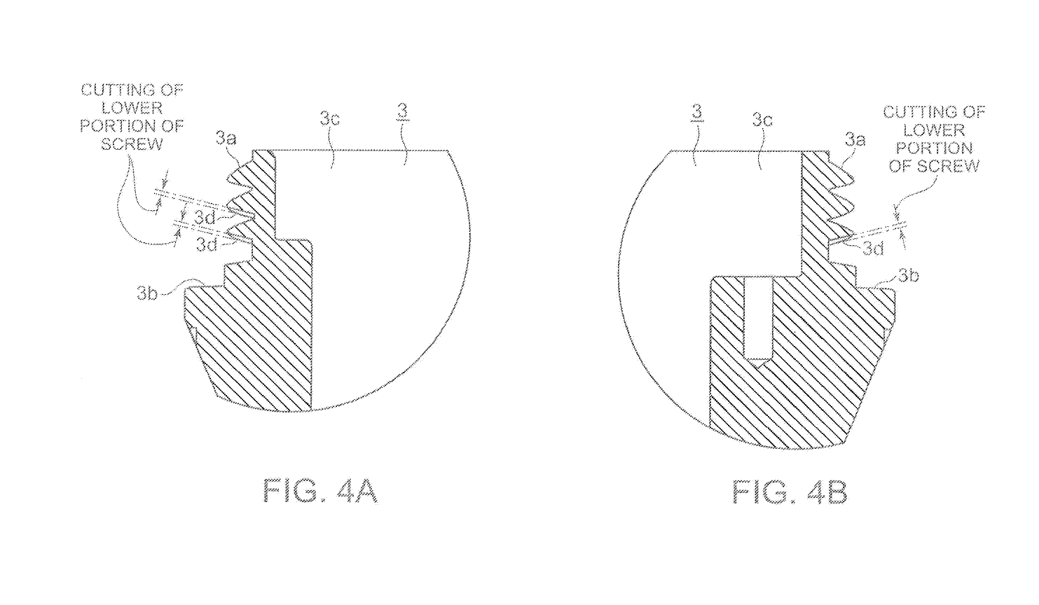

As illustrated in FIGS. 3A to 4B, the body 3 is made of synthetic resin or metal. In this embodiment, in order to constitute an outer member of the base-attached lamp, the body 3 is formed in a cylindrical body forming a hollow cylinder having the opening 3c at the side of one end with aluminum, integrally forms the body-side screw portion 3a screwing into the screw portion 2a of the cover member 2 in the outer circumferential surface of the opening 3c, and integrally forms the body-side step portion 3b formed to be continuous to the body-side screw portion 3a and face the step portion 2b of the cover member 2 at a predetermined interval.

In this embodiment, similar to the screw portion 2a of the cover member 2, the body-side screw portion 3a includes two screws and is provided with two dents 3a1 of the same number as the two screws at an equivalent interval of 180° in a radial direction from the center of a circle (refer to FIG. 3A). The two dents 3a1 are formed to have a width dimension where the 6 screw portions 2a of the cover member 2 are fitted. The body-side screw portion 3a that is cut by the two dents 3a1 is formed such that spirals of screw threads constituting the screws are continues as the two screws. In addition, bottom surfaces of the screw threads after the second thread (the uppermost portion is the first screw thread in FIGS. 3A to 4B) in the screw threads are cut and the concave portions 3d are formed.

In this embodiment, the packing 4 is made of an O ring. As illustrated in FIGS. 1A and 1B, the packing is made of silicone resin or synthetic rubber and is disposed in a space portion S where a cross-section formed by making the step portion 2b of the cover member 2 and the body-side step portion 3b of the body 3 face each other and a cross-section has an approximately rectangular shape. Thereby, the O ring 4 is interposed between the opening 2c of the cover member 2 and the opening 3c of the body 3.

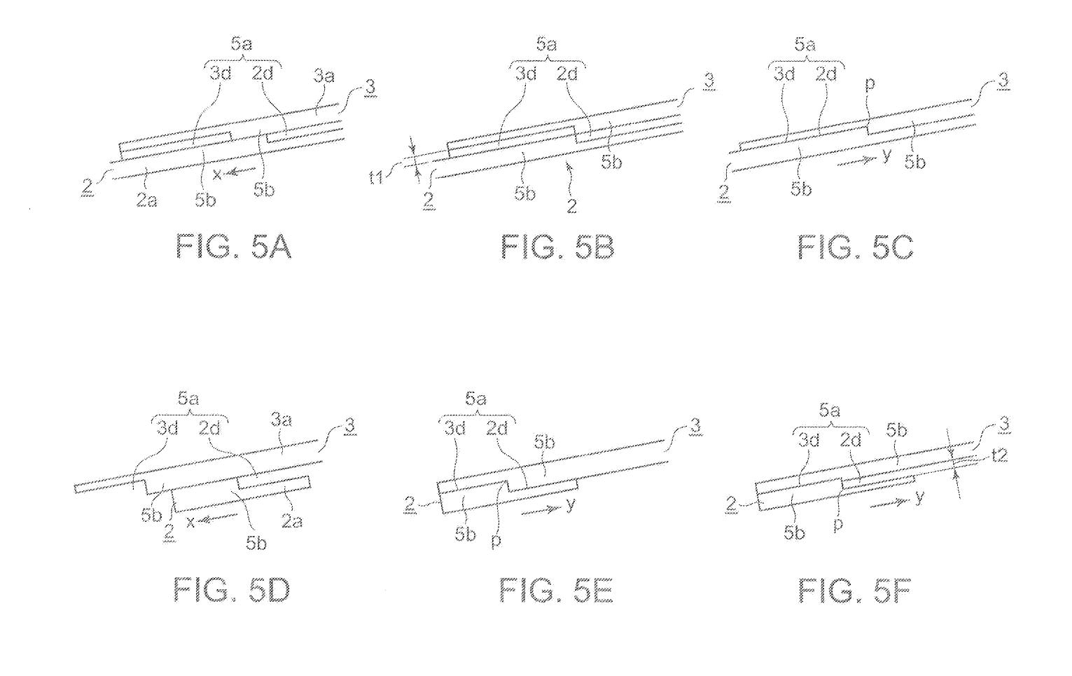

As illustrated in FIGS. 5A to 5F, the rotation stopping member 5 includes a concave portion 5a and a convex portion 5b that are formed to face at least one of the screw portion 2a of the cover member 2 and the body-side screw portion 3a of the body 3. In this embodiment, the rotation stopping member 5 includes the concave portion 5a and the convex portion 5b that are formed in both the cover member 2 and the body 3.

That is, as illustrated in FIG. 5A, the concave portion 5a of the rotation stopping member 5 of the side of the cover member 2 is the concave portion 2d where the top surface of the screw thread of the screw portion 2a is cut and the convex portion 5b is a remaining portion where the top surface of the screw thread is not cut. In addition, the concave portion 5a of the rotation stopping member 5 of the side of the body 3 is the concave portion 3d where the bottom surface of the screw thread of the body-side screw portion 3a is cut and the convex portion 5b is a remaining portion where the top surface of the screw thread is not cut.

Thereby, if the screw portion 2a of the cover member 2 and the body-side screw portion 3a of the body 3 are aligned and screwed (direction of an arrow x in FIG. 5A), as illustrated in FIGS. 5B and 5C, the concave portion 2d (concave portion 5a) where the top surface of the screw thread of the screw portion 2a of the cover member 2 is cut and the concave portion 3d (concave portion 5a) where the bottom surface of the screw thread of the body-side screw portion 3a of the body 3 is cut overlap and are fitted (refer to FIG. 5C). As a result, the remaining portion (convex portion 5b) where the top surface of the screw thread of the cover member 2 is not cut and the remaining portion (convex portion 5b) where the top surface of the screw thread of the body 3 is not cut are engaged with each other at a p point in the drawings and rotation thereof is stopped. That is, rotation of the cover member 2 that rotates in a leftward direction, the direction of an arrow y in FIG. 5C, is stopped with respect to a loosening direction.

As illustrated in FIG. 5B, the concave portion 5a and the convex portion 5b of the rotation stopping member are not engaged in a non-fitted state and in this embodiment, the cover member 2 moves upward in the drawings and is fitted (refer to FIG. 5C). In the movement in the upward direction, the cover member 2 is moved upward by the reactive force (direction of an arrow z in FIG. 5B) generated when the O ring 4 is compressed and is engaged.

In the mounting of the cover member 2 and the body 3, the O ring 4 is previously fitted into the body-side step portion 3b of the body 3 and the screw portion 2a of the cover member 2 and the body-side screw portion 3a of the body 3 are screwed while the screw portion 2a of the cover member 2 is aligned and inserted using the two dents 3a1 of the body 3 as marks. The screwing is performed while the O ring 4 is compressed and the screwing is stopped when a contact (slight engagement) of the concave portion 5a and the convex portion 5b of the rotation stopping member 5 is obtained by the touch of the hands. If the screwing is stopped and the hands are separated, the cover member 2 is moved upward slightly (by the dimension t1 of FIG. 5B) by the reactive force of the O ring 4, the concave portion 5a and the convex portion 5b of the rotation stopping member 5 are completely engaged, and the rotation of the cover member 2 in the loosening direction is prevented. When the cover member 2 and the body 3 are compulsorily separated, the cover member 2 may rotate in a reverse direction while being pressed with respect to the side of the body 3 against the reactive force of the O ring 4.

At this time, aligning can be performed using the two dents 3a1 of the same number as the two screws as the marks and the appropriate fitting position can be simply and surely determined. Therefore, an assembling property can be improved. Since the number of screws is two, the rotational number until fitting decreases as compared with the case of using one screw and workability at the time of assembling is improved. At the same time, the rubbing amount of the O ring 4 decreases and the difficulty in screwing due to the friction at the time of the assembling can be resolved. In other words, in this embodiment, the work for performing the screwing while compressing the O ring can be easily performed using the two screws. In addition, deterioration of the O ring 4 can be decreased.

As described above, at the same time as mounting of the cover member 2 to the body 3, the O ring 4 is compressed and adhered closely by each inner wall of the space portion S forming the rectangular shape and the cover member 2 and the body 3 are sealed to become an airtight state. At this time, as illustrated in FIGS. 1A and 1B, the O ring 4 is compressed at the two places (a-a point in the drawings) of a horizontal surface and a vertical surface of the step portion 2b of the cover member 2 and the two places (b-b point in the drawings) of a horizontal surface and a vertical surface of the body-side step portion 3b of the body 3 and contacts. For this reason, watertight and airtight portions become the two places and an effect of when the two O rings are used is obtained. Thereby, reliability of the watertight and airtight properties can be greatly improved and the watertight and airtight properties can be simply and surely realized by one O ring even when the strong watertight and airtight properties are required.

As described above, at the same time as the mounting of the cover member 2 to the body 3, stopping of the rotation of the cover member 2 with respect to the body 3 is automatically performed. In other words, stopping of the rotation can be automatically performed by screwing the cover member 2 into the body 3, without performing the particular operation and work to stop the rotation. Thereby, the rotation can be easily and surely stopped and the workability at the time of the assembling can be further improved without using an adhesive or a screw to stop the rotation, and a manufacturing cost can be decreased.

In the cover member mounting device 1 according to this embodiment described above, the concave portion 5a and the convex portion 5b of the rotation stopping member 5 are provided in both the cover member 2 and the screw portion of the body 3. As illustrated in FIGS. 5D and 5E, the concave portion 5a and the convex portion 5b may be configured to face any one of the cover member and the body. The concave portion 5a and the convex portion 5b may be formed to face at least one of the screw portion 2a of the cover member 2 and the body-side screw portion 3a of the body 3. As illustrated in FIG. 5F, in the engagement of the concave portion 5a and the convex portion 5b, a gap t2 may be formed. The number of each of the screw portions 2a and the body-side screw portions 3a is not limited to two and may be one or three or more. The screw portions 2a of the cover member 2 may be continuously formed. In the cover member 2, a peripheral portion having the screw portions 2a and a bottom portion (lens portion in the base-attached lamp) may be formed as separated members.

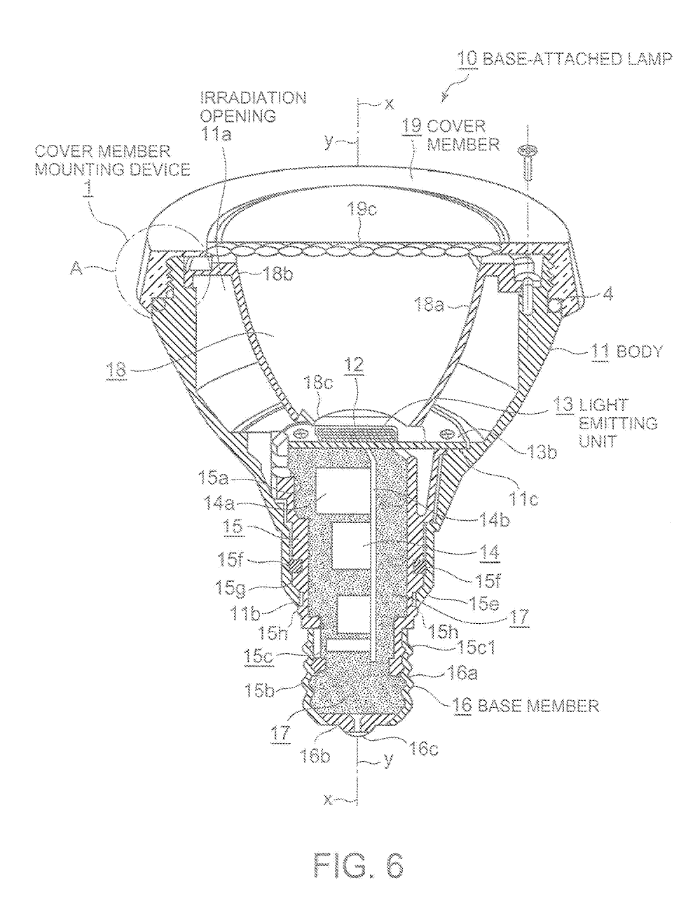

Next, the base-attached lamp that uses the cover member mounting device 1 having the above configuration will be described. In this embodiment, a beam-type base-attached lamp that can be substituted for an existing reflective incandescent lamp is configured. As illustrated in FIGS. 6 to 8, a base-attached lamp 10 includes a cover member 19 that is mounted by the cover member mounting device 1 having the above configuration and has a light transmitting property, a body 11 that has an irradiation opening 11a at the side of one end, a light emitting unit 13 that is disposed to face the cover member 19 in the body, and a base member 16 that is provided at the side of the other end of the body.

The body 11, constitutes an outer member that is made of one or more materials among metal having superior thermal conductivity, ceramic, and synthetic resin having thermal conductivity. In this embodiment, the body 11 is made of aluminum, has a horizontal cross-sectional shape that is an approximately circular shape, and is configured in a cylindrical body that forms a hollow cylinder having the irradiation opening 11a with the large diameter at the side of one end and having the opening 11b with the small diameter at the side of the other end. In an approximately intermediate portion in the body 11, a substrate supporting portion 11c that forms a planar shape is integrally formed such that an annular step portion is formed. The opening 11b with the small diameter at the side of the other end is formed to have a dimension of the inner diameter where the base member 16 to be described below can be inserted.

The outer circumferential portion of the body 11 is provided to form an approximately, conical tapered surface where the diameter decreases sequentially from the side of one end to the side of the other end along a central axis of the cylindrical body, that is, an optical axis x-x and is formed in a shape in which the exterior is approximated to an outer circumferential portion in the existing reflective incandescent lamp and a silhouette of a neck portion. The body 11 that has the above configuration is processed by casting, forging, or cutting, is bake-coated with acryl in the outer circumferential portion, and is configured to have the exterior of a metallic silver color or a white color.

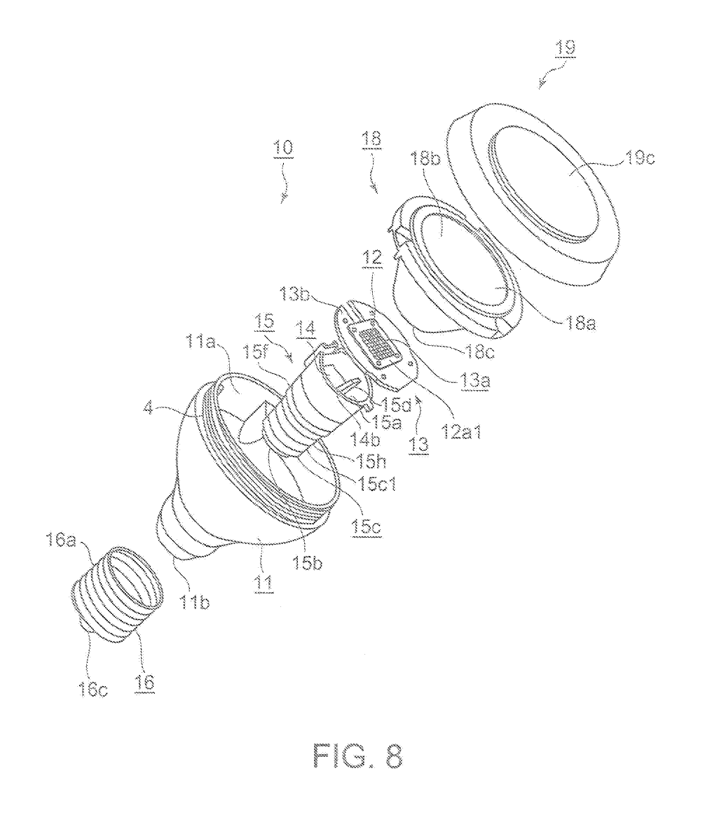

In the body 11 that has the above configuration, the light emitting unit 13 that is configured using the solid-state light emitting element 12 is stored and disposed to face the cover member 19. As illustrated in FIG. 8, the light emitting unit 13 includes a light emitting module 13a where the solid-state light emitting element 12 is disposed in a planar shape and a substrate 13b where the light emitting module is disposed. The solid-state light emitting element 12 is configured using a light emitting diode (hereinafter, referred to as “LED”) in this embodiment. The solid-state light emitting element 12 is configured using the plural LEDs that include blue LED chips having the same performance and have high brightness and a high output, and the light emitting module 13a is configured by mounting each LED 12 to a wiring substrate 12a1.

The light emitting module 13a is configured as follows. That is, the wiring substrate 12a1 is configured using a member made of metal or ceramic that is approximately square and has superior thermal conductivity, in this embodiment, a thin flat plate where an insulating layer is formed on a substrate made of aluminum. In the light emitting module 13a, a bank portion where an inner circumferential surface forms an approximately square shape is formed in a center portion of one surface side (surface side) and a shallow concave portion having a square shape is formed. The plural LEDs 12 (blue LED chips) are mounted in the concave portion in a matrix using a COB technology. In addition, a sealing member where a yellow phosphor is dispersed and mixed is coated or filled with respect to the mounted LEDs 12 and the light emitting module 13a that forms a planar shape with an approximately square shape is configured.

The light emitting module transmits blue light that is radiated from the blue LED chips and converts the blue light into yellow light by the yellow phosphor. The transmitted blue light and yellow light are mixed with each other and white light is radiated. The light emitting module 13a that has the above configuration is disposed on the substrate 13b and constitutes the light emitting unit 13. Since the substrate 13b functions as a heat radiating member, the substrate 13b is configured using a member having superior thermal conductivity, in this embodiment, an aluminum material that forms an approximately circular plate shape to be relatively thick, the light emitting module 13a is adhered closely and fixed to the flat center portion by a fixing unit such as a screw, and the heat that is generated from each LED 12 is transmitted from the wiring substrate 12a1 to the substrate 13b. The wiring substrate 12a1 may be formed integrally with the substrate 13b. In this case, the thermal conductivity is improved and a heat radiation property is improved. Thereby, the light emitting unit 13 where the LED 12 serving, as the solid-state light emitting element is disposed to form an approximately square planar shape is configured.

The light emitting unit 13 that has the above configuration is stored and disposed in the body 11. That is, the back surface side of the substrate 13b is adhered closely with respect to the substrate supporting portion 11c configured using a flat step portion and is supported and fixed by the fixing unit such as the screw. Thereby, the heat of the LED 12 that is transmitted from the wiring substrate 12a1 to the substrate 13b is transmitted to the body 11 made of the aluminum and is radiated to the outside. The substrate 13b may be formed integrally with the body 11. In this case, the thermal conductivity is improved and the heat radiation property is improved. As illustrated in FIG. 6, the optical axis x-x of the light emitting unit 13 and the central axis y-y of the body 11 are approximately aligned and a light source body that has an approximately circular light emitting surface when viewed two-dimensionally is configured as a whole.

In addition, an insulating case 15 is stored in the body 11 having the above configuration and a lighting device 14 is stored in the insulating case. That is, the insulating case 15 is configured in a cylindrical body that forms a cylindrical shape in which both ends made of synthetic resin having an electrical insulating property, in this embodiment, PBT resin are opened. The opening 15a at the side of one end of the cylindrical body is disposed to face the back surface side of the substrate 13b of the light emitting unit 13 and an electric line (not illustrated in the drawings) that is connected to an output terminal of the lighting device 14 is inserted.

In the opening 15b of the side of the other end of the cylindrical body, a base supporting portion 15c is integrally formed, a screw portion 15c1 is formed integrally in an outer circumferential surface of the base supporting portion 15c such that a base member 16 to be described below can be screwed. In an inner circumferential surface of the cylindrical body, support grooves 15d (refer to FIG. 8) that are configured using a pair of longitudinal grooves to support the lighting device are formed integrally in a longitudinal direction. In an outer circumferential surface of the cylindrical body, a support step portion 15e to fix the cylindrical body to the body 11 and a support concave portion 15g that is configured using a ring-like horizontal groove to it a packing, in this embodiment, the O ring 15f are integrally formed.

The lighting device 14 is stored in the insulating case 15 having the above configuration and the base member 16 is mounted to the base supporting portion 15c. First, the lighting device will be described. As illustrated in FIG. 6, the lighting device 14 includes a circuit component 14a that constitutes a lighting circuit of each LED 12 and a circuit board 14b on which the circuit component is mounted. The lighting circuit is configured to convert an alternating current voltage of 100 V into a direct current voltage of about 24 V and supply a direct current of a constant current to each LED 12. The circuit board 14b is made of a glass epoxy material that forms a strip shape, the circuit component 14a configured using an electronic component is mounted on a single surface or both surfaces, the circuit board 14b is inserted and fitted into the pair of supporting grooves 15d (refer to FIG. 8) formed in the inner surface of the insulating case 15 in a longitudinal direction, and the lighting device 14 is stored in the insulating case 15 in a longitudinal direction and is supported. The electric line connected to the output terminal of the circuit board 14b and an input line (not illustrated in the drawings) that is connected to the base member 16 is connected to an input terminal.

As illustrated in FIG. 6, the base member 16 is configured with a base of an Edison type, in this embodiment, an E26 type equal to the existing reflective incandescent lamp, and includes a cylindrical shell portion 16a that is made of conductive metal having a screw thread, in this embodiment, copper plate and an eyelet portion 16c that is provided on a top portion of, a lower end of the shell portion with the insulating portion 16b therebetween. The base member 16 is supported by fitting the opening of the shell portion 16a into the screw portion 15c1 of the base supporting portion 15c in the insulating case 15 and screwing the screw thread. Thereby, the base member 16 is mounted to the side of the other end of the insulating case 15 and the body 11 made of the aluminum and the base member 16 are electrically insulated from each other. At this time, the input line that is previously led from the input terminal of the circuit board 14b is connected to the base member 16.

As described above, a filling material 17 is filled in a state in which the lighting device 14 is stored in the insulating case 15 and the base member 16 is mounted to the side of the other end. The filling material 17 has an electrical insulating property and thermal conductivity, has elasticity in a solidified state, and uses an adhesive made of synthetic resin such as silicone resin or epoxy resin having a watertight property and an adhesive property, in this embodiment, silicone resin. At the time of the filling, the filling material 17 that is made of the liquid silicone resin is injected from the opening 15a of the side of one end of the insulating case 15, in a state in which the lighting device 14 is stored and the base member 16 is mounted to the side of the other end and the base member 16 and the lighting device 14 are connected by an electric line. Thereby, as illustrated in FIG. 6, the liquid silicone resin flows along the inner surface of the insulating case forming the cylinder to cover the circuit component 14a and the circuit board 14b of the lighting device 14 stored in the insulating case 15, and flows to the entire space in the shell portion 16a of the base member 16 from the opening 15b of the side of the other end of the insulating case 15. In addition, the silicone resin is injected until the silicone resin overflows from the opening 15a of the side of one end of the insulating case 15, is cured under a high-temperature atmosphere, and is stabilized.

The filling material 17 is preferably filled into the entire space of the insulating case 15 and the shell portion 16a. However, the filling material 17 may not be filled into the entire space and may be filled into the partial space. That is, all or a part of the circuit component 14a and the circuit board 14b of the lighting device 14 and the portion between the base supporting portion 15c of the insulating case 15 and the shell portion 16a of the base member 16 may be covered with the filling material 17 and may be supported. The work for curing the filling material 17 can be performed in a stable state, because the filling material 17 can be cured in a single body of the insulating case 15 where the lighting device 14 and the base-attached member 16 are assembled, before the insulating case 15 is assembled in the body 11. In a state in which the insulating case 15 is assembled in the body 11, because the body 11 is big and forms a circular shape, it becomes difficult to stably perform the work.

Thereby, the circuit component 14a and the circuit board 14b in the insulating case 15 are sufficiently covered with the silicone resin, the silicone resin is filled into the shell portion 16a, the inner portion and the outer portion become watertight, airtight, and isolated, and the screw portion of the shell portion 16a of the base member 16 and the base supporting portion 15c of the insulating case 15 is sealed in an airtight state and is fixed. Thereby, infiltration of water or dusts from the base member 16 can be surely prevented and reliability of the lighting device can be improved.

The circuit board 14b is firmly supported in the insulating case by the filling material 17 having the elasticity without backlash. Therefore, the component drop or disconnection of the input line in the shell portion 16a are not generated, the circuit board 14b is buried by the filling material having the electrical insulating property, the electrical insulating property is sufficiently maintained, and high reliability can be secured.

Since the circuit board 14b is fixed by the filling material 17 without being pressed and fixed to the insulating case 15, the stress due to pressing is not applied to the circuit component 14a and the circuit board 14b. Therefore, reliability of the circuit can be improved. At the same time, the heat that is generated from the circuit component 14a can be transmitted to the base member 16 made of the copper plate through the filling material 17 having the thermal conductivity and can be effectively radiated to the outside. As a result, reliability of the lighting device 14 can be further improved.

Thereby, the fixing of the base member 16 and the watertight structure of the base member can be achieved by using the filling material to realize the electrical insulating property of the lighting device 14 and the work for filling the filling material. In other words, the supporting of the lighting device 14, the fixing of the base member 16, and the watertight structure of the base member can be realized by one component of the filling material and one work for injecting the filling material. Similar to the existing reflective incandescent lamp, the base-attached lamp 10 that is superior in the weather-resistant property, the watertight property, and the electrical insulating property and uses the beam-type LED suitable for use outdoors in particular as the light source is configured.

As described above, the insulating case 15 where the lighting device 14 is stored and the base member 16 is mounted to the base supporting portion 15c of the side of the other end is inserted from the irradiation opening 11a of the side of one end of the body 11 in a state in which the base member 16 is downward, is inserted into the opening 11b with the small diameter at the side of the other end, and protrudes from the side of the other end of the body 11. Thereby, the base member 16 is provided at the side of the other end of the body 11, the support step portion 15e of the insulating case 15 is placed on the inner circumferential surface of the body 11, and the support step portion 15e is fixed to the inner circumferential surface of the body 11 by the fixing unit such as the screw.

At this time, a small convex portion 15h is formed integrally on the outer circumferential surface of the side of the other end of the insulating case 15 and an outer diameter dimension of the convex portion 15h is slightly larger than an inner diameter dimension of the small opening 11b of the side of the other end of the body 11. Thereby, the insulating case 15 is inserted into the opening 11b of the side of the other end of the body 11 by pressing, the convex portion. 15h is locked by overriding the opening 11b, and the insulating case 15 is firmly fixed to the body 11. In this case, the screw to fix the insulating case 15 to the body 11 may not be provided. Thereby, the insulating case 15 can be fixed without using the adhesive to fix the insulating case 15 to the body 11, and efforts or costs at the time of assembling can be prevented from increasing, without causing the complicated work such as adding the components or curing the adhesive.

In a state in which the O ring 15f is fitted into the support concave portion 15g formed in the outer circumferential portion of the insulating case 15, the insulating case 15 is inserted by pressing against the elasticity of the O ring 15f. Thereby, the O ring 15f is adhered closely to the inner circumferential surface of the body 11 and is supported such that the insulating case 15 and the body 11 become an airtight state. The electric line that is connected to the output terminal of the circuit board 14b is led from the opening 15a of the side of one end of the insulating case 15 and is connected to the LED 12 of the substrate 13b constituting the light emitting unit 13.

In FIG. 6, a reflector 18 controls distribution of light that is radiated, from the light emitting unit 13 and a cover member 19 forms a globe that is mounted by the cover member mounting device 1 having the above configuration. First, the reflector will be described. The reflector 18 is made of metal or synthetic resin, in this embodiment, PBT resin, and is integrally formed in a mortar shape to have an emission opening 18b formed of a wide opening to radiate light at the side of one end and an incidence opening 18c formed of a small opening at the side of the other end, such that a reflection surface 18a forms a rotation paraboloidal surface. The reflection surface 18a is formed in a specular surface where aluminum deposition finishing is performed.

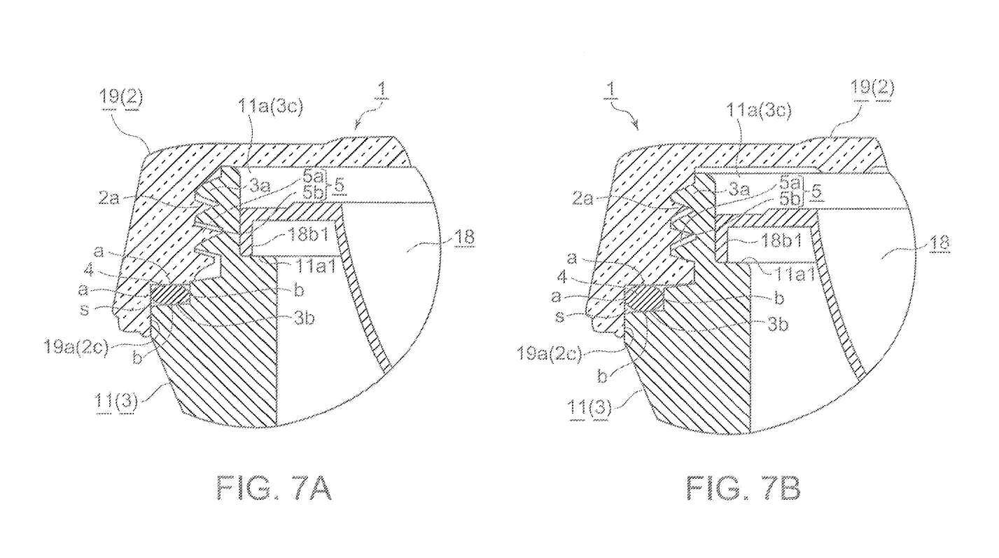

The reflector 18 that has the above configuration is supported to the irradiation opening 11a of the side of one end of the body 11. As illustrated in FIGS. 6 to 7B, an annular step portion 11a1 is formed integrally in the irradiation opening 11a of the body 11 at the inner circumferential side, and a flange portion 18b1 that is formed integrally in the wide emission opening 18b of the reflector 18 is placed on the step portion and is fixed by the fixing unit such as the screw. Thereby, as illustrated in FIG. 6, the optical axis of the reflector 18 is aligned with the optical axis x-x of the light emitting unit 13, the incidence opening 18c of the reflector 18 is disposed to face the light, emitting module 13a to surround the entire light emitting module 13a, and the light that is radiated from the light emitting module 13a is received by the incidence opening 18c without light loss, is reflected on the reflection surface 18a, and is radiated from the emission opening 18b.

The cover member 19 constitutes the globe of the lamp. For example, the cover member 19 is made of a material such as thick synthetic resin or glass and is formed in a shallow tray shape that is approximated to a silhouette of the globe of the existing reflective incandescent lamp having the opening 19a in one end, using acrylic resin which is transparent in this embodiment, or which may be semitransparent like a milky white color so as to have a light diffusing property. The cover member 19 is mounted to the body 11 by the cover member mounting device 1 and the rotation thereof is stopped. The rotation stopping member in the base-attached lamp 10 according to this embodiment has the same structure as that of the cover member mounting device 1 described above. In FIGS. 7A and 7B that are enlarged views of the portion (A portion in FIG. 6) of the cover member mounting device in the base-attached lamp 10, the same components as those of the cover member mounting device 1 are denoted by the same reference numerals, and the detailed description thereof will not be repeated. The right portion that faces the A portion of FIG. 6 in the base-attached lamp 10 has the same structure. In FIG. 6, a lens portion 19c includes plural convex spherical surfaces that are formed integrally in the bottom portion of the inner side of the tray of the cover member 19. In the cover member 19, the peripheral portion having the screw portion 2a and the bottom portion (lens portion 19c placed in the base-attached lamp) may be formed as separate members.

Therefore, according to the base-attached lamp 10 according to this embodiment, aligning can be performed using the two dents of the same number as the two screws as the marks, and the appropriate fitting position can be simply and surely determined. Therefore, an assembling property of the base-attached lamp can be improved. Since the number of screws is two, the rotational number until fitting decreases as compared with the case of using one screw and workability at the time of the assembling is improved. At the same time, the rubbing amount of the packing, in this embodiment, the O ring 4 decreases and the difficulty in screwing due to the friction at the time of the assembling can be resolved. In other words, in the base-attached lamp according to this embodiment, the work for performing the screwing while compressing the O ring can be easily performed using the two screws. In addition, deterioration of the O ring can be decreased.

At the same time, as illustrated in FIGS. 7A and 7B, the O ring 4 is compressed at the two places (a-a point in the drawings) of a horizontal surface and a vertical surface of the cover member 19 and the two places (b-b point in the drawings) of a horizontal surface and a vertical surface of the body 11 and contacts. Therefore, watertight and airtight portions become the two places and an effect of when the two O rings are used is obtained. The securing of the watertight and airtight properties can be automatically performed by the operation of screwing the cover member 19 of the base-attached lamp 10 into the body 11, without performing the particular operation and work to secure the watertight and airtight properties. Thereby, reliability of the watertight and airtight properties can be greatly improved and the watertight and airtight properties can be simply and surely realized by one O ring even when the strong watertight and airtight properties are required. In particular, in the beam-type base-attached lamp that is used outdoors, a base-attached lamp that has a watertight function equal to or superior to that of the existing reflective incandescent lamp can be provided. In this kind of base-attached lamp, the LED 12 that becomes the light source emits heat, the internal temperature of the body 11 increases, expansion and contraction are repeated in an environment where the temperature difference with the outer air is severe, such as a winter season, and a use period is long. For this reason, the airtight property may be easily deteriorated. However, this can be resolved by adopting the cover member mounting device 1 described above.

At the same time as the mounting of the cover member 19 to the body 11, stopping of the rotation of the cover member 19 with respect to the body 11 can be automatically performed by screwing the cover member 19 into the body 11, without performing the particular operation and work to stop the rotation. Thereby, the stopping of the rotation of the cover member 19 in the base-attached lamp can be simply and surely performed, the workability at the time of assembling the base-attached lamp can be further improved without using an adhesive or a screw to stop the rotation, and a manufacturing cost can be decreased.

As described above, the outer circumferential portion of the body 11 that is configured to form an approximately conical tapered surface has an exterior shape to be continuous integrally in the cover member 19 of the tray shape constituting the globe and the beam-type base-attached lamp 10 that has the exterior shape and the dimension where the entire lamp is approximated to the silhouette of the existing reflective incandescent lamp is configured. As illustrated in FIG. 6, the optical axis of the cover member 19 is aligned with the optical axis x-x of the light emitting unit 13 and the reflector 18 and beam-type lighting where the light radiated from the emission opening 18b of the reflector 18 is condensed in a predetermined direction by the lens portion 19c of the cover member 19 can be performed. In particular, according to the base-attached lamp 10 according to this embodiment, desired light distribution control can be performed by an optical control function by the light transmitting cover member 19 having the lens portion 19c and an optical control function by the reflector 18. For this reason, various kinds of light distribution angles can be realized by selecting the cover member 19 and the reflector 18. For example, if the lineup of several components where the light distributions are different is performed in the cover member 19 and the reflector 18, the beam-type base-attached lamp that has various light distribution angles by the combination thereof can be simply configured.

Next, a sequence for assembling the base-attached lamp 10 having the above configuration will be described using FIG. 8. First, the circuit board 14b of the lighting device 14 is stored in the insulating case 15. At this time, the electric line that is connected to the output terminal of the circuit board 14b is led from the opening 15a of the side of one end of the insulating case 15 and the input line is led from the opening 15b of the side of the other end.

Next, the input line that is led from the opening 15b of the side of the other end of the insulating case 15 is connected to the shell portion 16a and the eyelet portion 16c of the base member 16. Next, the shell portion 16a of the base member 16 is screwed into the base supporting portion 15c of the insulating case 15. Next, the filling material 17 is injected from the opening 15a of the side of one end of the insulating case 15 until the filling material 17 overflows from the opening 15a. Next, the filling material 17 is cured under a high-temperature atmosphere.

Next, the base supporting portion 15c of the insulating case 15 to which the base member 16 is attached is inserted from the irradiation opening 11a of the side of one end of the body 11, is inserted into the opening 11b of the side of the other end, and protrudes from the side of the other end of the body. 11. At this time, the base supporting portion 15c is inserted by pressing against the elasticity of the O ring 15f fitted into the outer circumferential portion of the insulating case 15.

Next, the back surface side of the substrate 13b of the light emitting unit 13 to which the light emitting module 13a is previously mounted is adhered closely to the substrate supporting portion 11c formed of the smooth step portion in the body 11 and is fixed by the screw. Next, the flange portion 18b1 of the reflector 18 is placed on the annular step portion 11a1 of the body 11 and is fixed by the screw, and the incidence opening 18c of the reflector 18 is made to face the light emitting module 13a of the light emitting unit 13.

Next, the opening 19a of the cover member 19 is fitted into the body 11 to cover the light emitting unit 13 and the reflector 18, using the cover member mounting device 1 described above, and the screw portion 2a of the cover member 19 is fixed to the body-side screw portion 3a of the body 11 by screwing. At this time, the screw portion is fixed by screwing the screw portion against the elasticity of the O ring 4.

As described above, the beam-type base-attached lamp 10 that uses the LED 12 as the light source and can be substituted for the existing reflective incandescent lamp where the base is configured in an E26 type is configured. In the base-attached lamp, the rotation of the cover member 19 can be surely stopped using the cover member mounting device 1, the mounting portion of the base member 16 is sealed by the filling material 17, the insulating case 15 and the body 11 are sealed by the O ring 15f, and the cover member 19 and the body 11 are sealed by the O ring 4. By the simple configuration using the O ring and the simple unit by the screwing of the cover member 19 with respect to the body 11 performed at the time of the assembling or the pressing of the insulating case 15 with respect to the body 11, a base-attached lamp that has a watertight function equal to or superior to that of the existing reflective incandescent lamp and uses the beam-type LED to be completely watertight as the light source can be provided.

Next, an operation of the base-attached lamp 10 that has the above configuration will be described. If the base member 16 of the base-attached lamp 10 is mounted to a socket of a fixture, power is supplied to the base-attached lamp, and the base-attached lamp is turned on, the light is radiated from the planar light emitting module 13a that forms the approximately square shape of the light emitting unit 13. The radiated light is received in the incidence opening 18c of the reflector 18, is reflected by the reflection surface 18a in a direction along the optical axis x-x, and is condensed in a direction along the optical axis x-x by the lens portion 19c of the cover member 19, and lighting that has the same beam-type light distribution characteristic as that of the existing reflective incandescent lamp can be performed.

When the base-attached lamp 10 is disposed outdoors and is exposed to rain, because the cover member 19 and the body 11 can be surely sealed by the O ring 4 using the cover member mounting device 1, water does not infiltrate into the body 11. The water that is flown through the outer circumferential portion of the body 11 does not infiltrate into the body 11, because the insulating case 15 and the body 11 are sealed by the O ring 15f. The water that is flown through the base member 16 does not infiltrate into the base, because the base member 16 is sealed by the filling material 17. Similar to the water, the dusts do not infiltrate. Thereby, the base-attached lamp 10 that is completely watertight due to the watertight and airtight properties by the O ring 4, the O ring 15f, and the filling material 17 is configured.

If the base-attached lamp 10 is turned on, the temperature of the LED 12 increases and the heat is generated. The heat is transmitted from the wiring substrate 12a1 made of aluminum to the substrate 13b made of the same aluminum, is transmitted to the body 11 made of the aluminum to which the substrate 13b is fixed, and is radiated to the outside. The body 11 is formed to have an approximately conical tapered surface. In the body 11, the exterior shape is configured in a shape approximated to the silhouette of the outer circumferential portion and the neck portion in the existing reflective incandescent lamp and the outer circumferential portion that achieves a heat radiation function has a wide area. For this reason, the heat that is transmitted to the body 11 is discharged gradually from the outer circumferential portion and continuous heat radiation is performed. By the effective heat radiation function, the temperature of the LED 12 can be suppressed from increasing, light emission efficiency of the LED can be suppressed from being deteriorated, and the long lifespan can be realized.

At the same time, the heat that is generated from the circuit component 14a of the lighting device 14 can be transmitted to the base member 16 through the filling material 17 having the thermal conductivity and can be effectively radiated from the socket of the fixture to the outside through the fixture body, and the circuit board 14b that is buried by the filling material can be cooled down. Therefore, the temperature of the circuit component 14a can be suppressed from increasing and reliability of the electronic component can be improved.

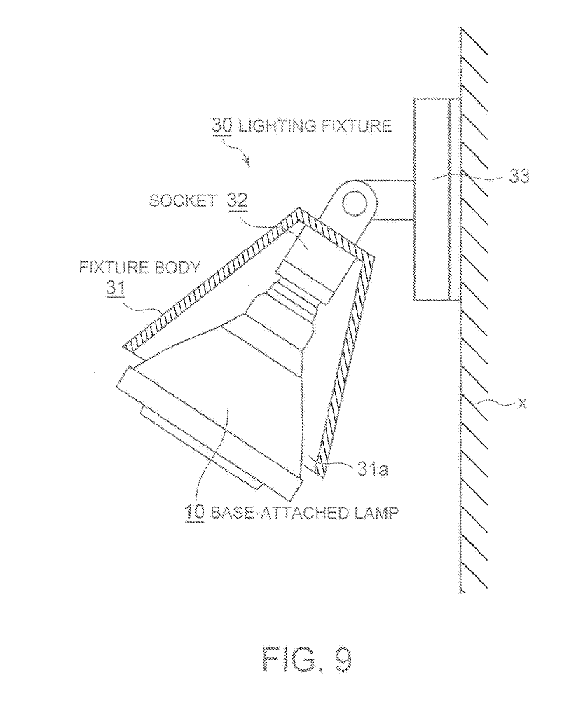

Next, the configuration of a lighting fixture that uses the bulb-type base-attached lamp 10 having the above configuration as the light source will be described. As illustrated in FIG. 9, a spotlight 30 is disposed on an external wall X of a store and uses the existing reflective incandescent lamp having the base of the E26 type as the light source. The spotlight 30 includes a metallic fixture body 31 that forms a shape of a bugle having an opening 31a in a bottom surface, a socket 32 that can screw the base of the E26 type provided in the existing reflective incandescent lamp, and a base portion 33 to which the fixture body 31 is rotatably mounted. For example, the fixture body 31 is made of a metallic plate such as a coated steel plate and the socket 32 is disposed in the center portion of a top plate.

In the existing spotlight 30 that is used for the reflective incandescent lamp having the above configuration, instead of the reflective incandescent lamp, the beam-type base-attached lamp 10 that uses the LED as the light source is mounted to save energy and increase the lifespan. That is, in the base-attached lamp 10 according to this embodiment, since the base member 16 is configured in the E26 type, the base member 16 can be inserted into the socket 32 of the spotlight 30 as it is.

The base-attached lamp 10 is configured such that the exterior shape is the shape approximated to the outer circumferential portion and the neck portion in the silhouette of the existing reflective incandescent lamp. For this reason, the neck portion can be smoothly inserted into the inner surface of the fixture body 31 around the socket without bumping and a conformance rate of the base-attached lamp 10 using the LED as the light source with respect to the existing lighting fixture is improved. Thereby, the existing spotlight can be simply changed to a spotlight of an energy saving type where the base-attached lamp 10 using the LED as the light source is disposed. The existing fixture and a lighting fixture having the new configuration can be configured in the same way.

If the power is supplied to the spotlight 30 having the above configuration, commercial power is supplied from the socket 32 to the base-attached lamp 10 through the base member 16, all of the LEDs are simultaneously turned on, white light is radiated, and lighting that has the same light distribution characteristic as that of the existing reflective incandescent lamp can be performed as described above. At the same time, since the base-attached lamp 10 according to this embodiment using the LED as the light source is used as the light source, brightness is not lowered over a long period, reliability of the electronic components can be improved with the complete watertight property, and a lighting fixture that has the long lifespan and high reliability can be provided. Since the cover member 19 is mounted to the body 11 by the cover member mounting device 1, the rotation is stopped in the cover member 19, when the base-attached lamp 10 is exchanged. Therefore, only the cover member 19 rotates, the lamp can be easily separated from the socket 32, and the lamp can be surely rotated and can be exchanged.

### Second Embodiment

Next, another embodiment where the invention is applied will be described below. The same components as those of the first embodiment are denoted by the same reference numerals and the detailed description thereof will not be repeated.

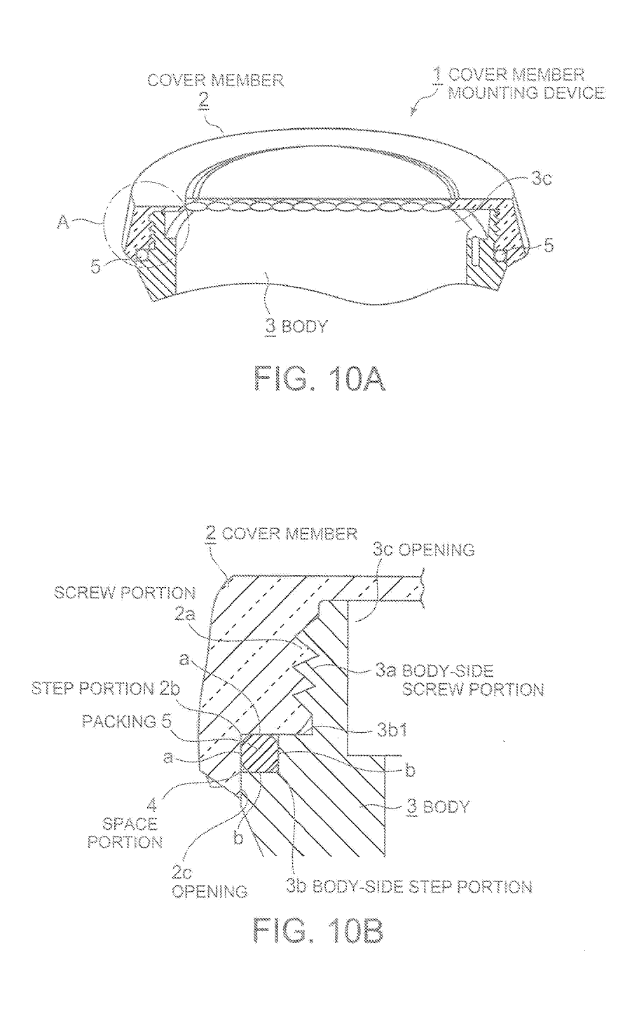

First, the cover member mounting device will be described. In this embodiment, the cover member mounting device that is used in a beam-type base-attached lamp is configured. As illustrated in FIG. 10, a cover member mounting device 1 includes a cover member 2 where a screw portion 2a is formed and an annular step portion 2b is formed to be continuous to the screw portion, a body 3 where a body-side screw portion 3a screwed into the screw portion 2a of the cover member 2 is formed and a body-side step portion 3b is formed to face the step portion 2b of the cover member 2, and a packing 5 that is disposed in a space portion 4 formed by making the step portion 2b and the body-side step portion 3b of the cover member 2 face each other.

The cover member 2 is made of synthetic resin or metal. In this embodiment, in order to constitute a globe of the base-attached lamp, the cover member 2 forms a circular tray shape having the opening 2c in one end with transparent acrylic resin, integrally forms the screw portion 2a in the inner circumferential surface of the opening, and integrally forms an annular step portion 2b that is continuous to the screw portion 2a and leads to an opening end of the opening 2c.

The body 3 is made of synthetic resin or metal. In this embodiment, in order to constitute an outer member of the base-attached lamp, the body 3 is formed in a cylindrical body that forms a hollow cylinder having the opening 3c at the side of one end with aluminum, integrally forms the body-side screw portion 3a screwing into the screw portion 2a of the cover member 2 in the outer circumferential surface of the opening 3c, and integrally forms the body-side step portion 3b that is formed to be continuous to the body-side screw portion 3a and face the step portion 2b of the cover member 2.

The packing 5 is configured using the O ring in this embodiment. As illustrated in FIG. 10, the packing 5 is made of silicone resin or synthetic rubber and is disposed in the space portion 4 that is formed by making the step portion 2b of the cover member 2 and the body-side step portion 3b of the body 3 face each other and has a cross-section to be approximately rectangular.

In the mounting of the cover member 2 and the body 3, the O ring 5 is fitted into the body-side step portion 3b of the body 3 and the screw portion 2a of the cover member 2 and the body-side screw portion 3a of the body 3 are screwed. The screwing proceeds until the horizontal surface of the step portion 2b of the cover member 2 comes into contact with the step portion 3b1 of the body 3.

Thereby, at the same time as the mounting of the cover member 2 to the body 3, the O ring 5 is compressed and adhered closely by each inner wall of the space portion 4 forming the rectangular shape and the cover member 2 and the body 3 are sealed to become an airtight state. At this time, as illustrated in FIG. 10B, the O ring 5 is compressed and abut on the two places (a-a points in the drawings) of a horizontal surface and a vertical surface of the step portion 2b of the cover member 2 and the two places (b-b points in the drawings) of a horizontal surface and a vertical surface of the body-side step portion 3b of the body 3. As a result, watertight and airtight portions become the two places and an effect of when the two O rings are used is obtained. The securing of the watertight and airtight properties can be automatically performed by the operation of screwing the cover member 2 into the body 3, without performing the particular operation and work to secure the watertight and airtight properties. Thereby, reliability of the watertight and airtight properties can be greatly improved and the watertight and airtight properties can be simply and surely realized by one O ring even when the strong watertight and airtight properties are required. In the cover member 2, a peripheral portion having the screw portions 2a and a bottom portion (lens portion in the base-attached lamp) may be formed as separated members.

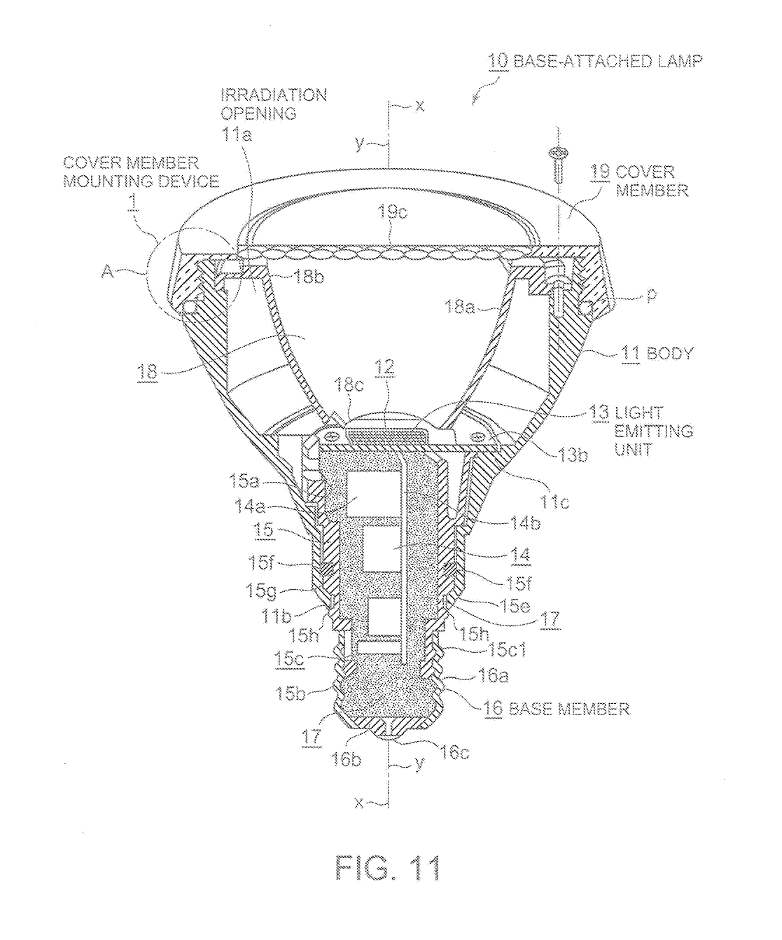

Next, the base-attached lamp that uses the cover member mounting device 1 having the above configuration will be described. In this embodiment, a beam-type base-attached lamp that can be substituted for the existing reflective incandescent lamp is configured. For this reason, as illustrated in FIGS. 11 to 13, a base-attached lamp 10 includes a cover member 19 that is mounted by the cover member mounting device 1 having the above configuration and has a light transmitting property, a body 11 that includes a cylindrical body having an irradiation opening 11a at the side of one end thereof, a light emitting unit 13 that is disposed to face the cover member 19 in the body, and a base member 16 that is provided at the side of the other end of the body.

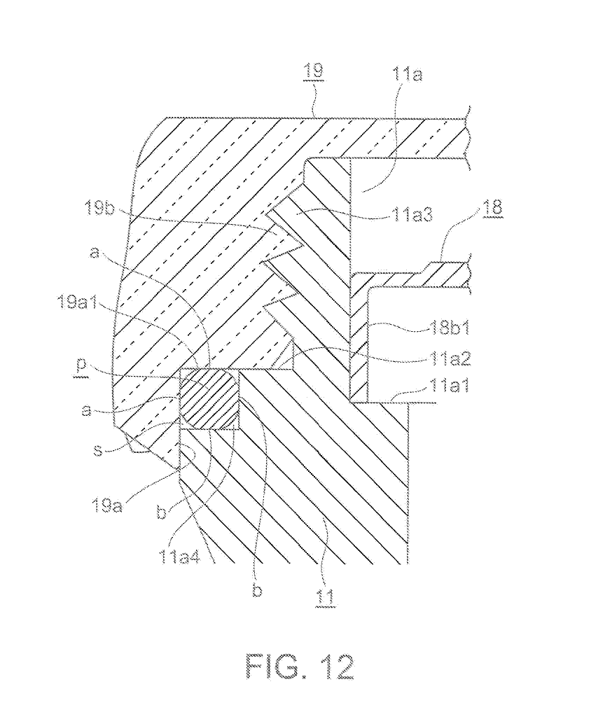

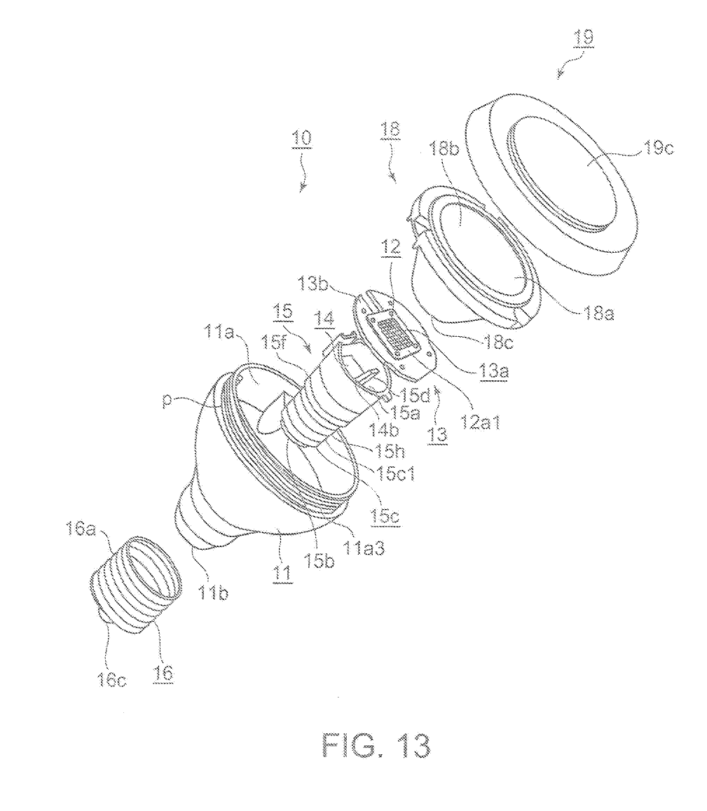

Since FIGS. 11 and 13 are equal to FIGS. 6 and 8 illustrating the first embodiment, the detailed description thereof will not be repeated. FIG. 12 is a diagram illustrating the detailed configuration of a cover member mounting device that does not have a rotation stopping member.

In FIG. 11, a reflector 18 controls distribution of light that is radiated from the light emitting unit 13 and a cover member 19 forms a globe that is mounted by the cover member mounting device 1 having the above configuration. First, the reflector will be described. The reflector 18 is made of metal or synthetic resin, in this embodiment, PBT resin, and is formed integrally in a mortar shape to have an emission opening 18b formed of a wide opening to radiate light at the side of one end and an incidence opening 18c formed of a small opening at the side of the other end, such that a reflection surface 18a forms a rotation paraboloidal surface. The reflection surface 18a is formed in a specular surface where aluminum deposition finishing is performed.

The reflector 18 that has the above configuration is supported to the irradiation opening 11a at the side of one end of the body 11. As illustrated in FIGS. 11 and 12, an annular step portion 11a1 is formed integrally in the irradiation opening 11a of the body 11 at the inner circumferential side, and a flange portion 18b1 that is formed integrally in the wide emission opening 18b of the reflector 18 is placed on the step portion and is fixed by the fixing unit such as the screw. Thereby, as illustrated in FIG. 11, the optical axis of the reflector 18 is aligned with the optical axis x-x of the light emitting unit 13, the incidence opening 18c of the reflector 18 is disposed to face the light emitting module 13a to surround the entire light emitting module 13a, and the light that is radiated from the light emitting module 13a is received by the incidence opening 18c without any light loss, is reflected on the reflection surface 18a, and is radiated from the emission opening 18b.

The cover member 19 constitutes the globe of the lamp. For example, the cover member 19 is made of a material such as thick synthetic resin or glass and is formed in a shallow tray shape that is approximated to a silhouette of the globe of the existing reflective incandescent lamp having the opening 19a in one end, using acrylic resin having a light diffusing property to be semitransparent like a milky white color, in this embodiment, to be transparent.

The cover member 19 is mounted to the body 11 by the cover member mounting device 1 described above. That is, in FIG. 12 that is an enlarged view of the portion (A portion in FIG. 11) of the cover member mounting device in the base-attached lamp 10, the screw portion 19b is formed integrally in the inner circumferential surface that becomes an edge of the tray, and the annular step portion 19a1 to store the packing, in this embodiment, the O ring p is formed integrally in the opening edge of the edge, that is, the edge portion to be the opening end of the opening 19a. As illustrated in FIG. 11, the lens portion 19c that includes plural convex spherical surfaces is formed integrally in the bottom portion in the tray.

The cover member 19 that has the above configuration is supported by screwing the cover member 19 into the irradiation opening 11a of the side of one end of the body 11. As illustrated in FIG. 12, the annular step portion 11a2 is formed integrally in the irradiation opening 11a of the body 11 at the outer circumferential side, the body-side screw portion 11a3 is formed integrally in the outer circumferential surface of the step portion, and the annular body-side step portion 11a4 is formed integrally in a lower portion of the body-side screw portion 11a3, that is, a shoulder portion of the step portion. The right portion that faces the A portion of FIG. 11 in the base-attached lamp 10 has the same structure. In the cover member 19, the peripheral portion having the screw portion 19b and the bottom portion (lens portion 19c in the base-attached lamp) may be formed as separate members.

Thereby, the opening 19a of the cover member 19 is fitted into the step portion 11a2 of the body 11 to cover the light emitting unit 13 and the reflector 18, and the cover member 19 is fixed to the body 11 by screwing the screw portion 19b of the cover member 19 into the body-side screw portion 11a3 of the body 11. At this time, the cover member 13 is screwed into the body 11 in a state in which the O ring p is previously fitted into the annular body-side step portion 11a4 of the body 11. The screwing proceeds until the horizontal surface Of the step portion 19a1 of the cover member 19 comes into contact with the step portion 11a2 of the body 11.

Thereby, the O ring p is disposed in the space portion S that is formed by making the body-side step portion 11a4 of the body 11 and an the step portion 19a1 of the cover member 19 face each other and has a cross-section to be approximately rectangular. By screwing the cover member 19 into the body 11, the O ring p is compressed and adhered closely by each inner wall of the space portion S forming the rectangular shape, and the cover member 19 and the body 11 are supported to become an airtight state.

By adopting the cover member mounting device 1 described above, as illustrated in FIG. 12, the O ring p is compressed and abut on the two places (a-a point in the drawings) of a horizontal surface and a vertical surface of the step portion 19a1 of the cover member 19 and the two places (b-b point in the drawings) of the horizontal surface and the vertical surface of the body-side step portion 11a4 of the body 11. As a result, watertight and airtight portions become the two places and an effect of when the two O rings are used is obtained. The securing of the watertight and airtight properties can be automatically performed by the operation of screwing the cover member 19 of the base-attached lamp 10 into the body 11, without performing the particular operation and work to secure the watertight and airtight properties. Thereby, reliability of the watertight and airtight properties can be greatly improved and the watertight and airtight properties can be simply and surely realized by one O ring even when the strong watertight and airtight properties are required.

In particular, by adopting the cover member mounting device 1 in the beam-type base-attached lamp that is used outdoors, a base-attached lamp that has a watertight function equal to or superior to that of the existing reflective incandescent lamp can be provided. In this kind of base-attached lamp, the LED 12 that serves as the light source is heated, the internal temperature of the body 11 increases, expansion and contraction are repeated in an environment where the temperature difference with the outer air is severe, such as a winter season, and a use period is long. For this reason, the airtight property may be easily deteriorated. However, this can be resolved by adopting the above-described cover member mounting device.

As described above, the outer circumferential portion of the body 11 that is configured to form an approximately conical tapered surface has an exterior shape to be continuous integrally with the cover member 19 of the tray shape constituting the globe and the beam-type base-attached lamp 10 is configured which has the exterior shape and the dimension where the entire lamp is approximated to the silhouette of the existing reflective incandescent lamp. As illustrated in FIG. 11, the optical axis of the cover member 19 is aligned with the optical axis x-x of the light emitting unit 13 and the reflector 18 and the beam-type lighting can be performed in which the light radiated from the emission opening 18b of the reflector 18 is condensed in a predetermined direction by the lens portion 19c of the cover member 19.

In particular, according to the base-attached lamp 10 according to this embodiment, desired light distribution control can be performed by an optical control function by the light transmitting cover member 19 having the lens portion 19c and an optical control function by the reflector 18. For this reason, various kinds of light distribution angles can be realized by selecting the cover member 19 and the reflector 18. For example, if several components of which the light distributions are different from each other are lined up in the cover member 19 and the reflector 18, the beam-type base-attached lamp that has various light distribution angles by the combination thereof can be simply configured.

FIG. 13 illustrates a sequence for assembling the base-attached lamp 10 having the above configuration. However, since FIG. 13 is equal to FIG. 8, the detailed description thereof will not be repeated.

As illustrated in FIG. 13, the opening 19a of the cover member 19 is fitted into the step portion 11a2 of the body 11 to cover the light emitting unit 13 and the reflector 18, using the cover member mounting device 1, and the screw portion 19b of the cover member 19 is fixed to the body-side screw portion 11a3 of the body 11 by screwing. At this time, the screw portion is fixed by screwing the screw portion against the elasticity of the O ring p.

As described above, the beam-type base-attached lamp 10 that uses the LED 12 as the light source and can be substituted for the existing reflective incandescent lamp where the base is configured in an E26 type is configured. In the base-attached lamp, the mounting portion of the base member 16 is sealed by the filling material 17, the insulating case 15 and the body 11 are sealed by the O ring 15f, and the cover member 19 and the body 11 are sealed by the O ring p using the above-described cover member mounting device 1. By the simple configuration using the O ring and the simple unit by the screwing of the cover member 19 with respect to the body 11 performed at the time of the assembling or the pressing of the insulating case 15 with respect to the body 11, a base-attached lamp that has a watertight function equal to or superior to that of the existing reflective incandescent lamp and uses the beam-type LED to be completely watertight as the light source can be provided.

Since an operation of the base-attached lamp 10 according to the second embodiment is the same as that of the first embodiment, the detailed description thereof will not be repeated. Since the configuration of the lighting fixture using the bulb-type base-attached lamp 10 configured in the second embodiment as the light source is the same as the configuration of FIG. 9 illustrating the first embodiment, the detailed description thereof will not be repeated.

The first embodiment and the second embodiment are described above. However, in the embodiments, the circuit board 14b of the lighting device 14 is supported by inserting and fitting the circuit board into the support groove 15d of the insulating case 15. However, the width dimension of the circuit board 14b may be slightly larger than the inner diameter dimension of the insulating case 15 forming the cylindrical shape, the insulating case 15 may be bent to have the cross-sectional shape forming the elliptical shape, the circuit board 14b may be inserted into the insulating case 15 bent in the elliptical shape, and the circuit board 14b may locked and supported to the insulating case 15 by returning of the shape of the insulating case to the circular shape. Thereby, the circuit board 14b can be smoothly inserted, the insulating case 15 and the circuit board 14b can be supported without increasing the number of components and by minimizing the stress with respect to the circuit board 14b and the circuit component 14a, and an assembling property can be improved and a manufacturing cost can be decreased.

The base member 16 of the base-attached lamp 10 is supported by screwing the base member into the base supporting portion 15c of the insulating case 15. However, the base member 16 may be supported by fitting the shell portion 16a, without forming the screw portion 15c1 of the base supporting portion 15c. The base member 16 may be supported by a caulking or an adhesive to be firmly fixed.

In this embodiment, the base-attached lamp 10 that has the cover member mounting device 1 is configured using the beam-type base-attached lamp that is approximated to the shape of the existing reflective incandescent lamp. However, the base-attached lamp 10 may be configured using a bulb type (A type or PS type) approximated to a shape of a general incandescent lamp, a ball type (G type), or a cylindrical type (T type). The base-attached lamp is not limited to the base-attached lamp approximated to the shape of the existing incandescent lamp and can be applied to various base-attached lamps that have various exterior shapes and uses.

The solid-state light emitting element 12 is not limited to the LED and a solid-state light emitting element that uses organic EL or semiconductor laser as a light emitting source may be allowed. The LED 12 is configured using the COB technology. However, the LED 12 may be configured in an SMD type. The solid-state light emitting element is preferably configured to emit white light. However, the solid-state light emitting element may be configured to emit red light, blue light, green light, or light of a color obtained by combining the various colors, according to the applications of the used lighting fixture.

The substrate 13b and the wiring substrate 12a1 are configured using the aluminum with the superior thermal conductivity. However, the substrate 13b and the wiring substrate 12a1 may be configured using metal such as copper or stainless. Further, the substrate 13b and the wiring substrate 12a1 may be configured using ceramic. The wiring substrate 12a1 may be configured using synthetic resin such as epoxy resin or a non-metallic material such as a glass epoxy material and a paper-phenol material. The shape of the light emitting unit 13 where the LED 12 is disposed in a planar shape may be a circular shape, a polygonal shape such as a rectangular shape or a hexagonal shape, and an elliptical shape to constitute a point module or a planar module, and any shape to obtain a desired light distribution characteristic may be allowed.

The body 11 is configured using the aluminum with the superior thermal conductivity. However, the body 11 may be configured using metal including at least one of copper (Cu), iron (Fe), and nickel (Ni). The body 11 may be configured using industrial materials such as aluminum nitride (AlN) and silicone carbide (SiC) or synthetic resin such as resin with high thermal conductivity. The body 11 is preferably configured using aluminum die casting. However, the body 11 may be formed by draw-shaping a metal plate such as aluminum.

The lighting device 14 may have a dimming function to modulate light from the solid-state light emitting element 12 or a toning function. The lighting device 14 may be completely stored and disposed in the insulating case 15 or may be partially stored in the base member 16. As described above, the lighting device 14 may be preferably incorporated in the bulb to be substituted for the existing reflective incandescent lamp. However, like a compact fluorescent lamp, the lighting device may be provided at the side of the fixture mounting the lamp as a separate device and may not be incorporated at the side of the bulb. The lens portion 19c of the cover member 19 is configured in a condensing type. However, the lens portion 19c may be configured in a diffusing type and the type thereof may be appropriately selected according to the applications.

As the base member 16, an Edison type E26 or E17 of the base is preferably used which is most widely used. In the material of the base member 16, the entire base may be formed using metal or the electrical connection portion may be configured using metal such as a copper plate and the other portion may be configured using synthetic resin. The base member 16 may be a base member that has a pin-type terminal or a base member that has an L-type terminal and is not limited to a specific base member.

In this embodiment, in the lighting fixture, a wall surface mounting type, a ceiling direct mounting implantation type, a suspending type, and a ceiling burying type are allowed. A globe, a shade, and reflector may be mounted as a light regulating object in a fixture body and the base-attached lamp that becomes the light source may be exposed. The number of base-attached lamps mounted to the fixture body is not limited to one and the plural base-attached lamps may be disposed. A large-scaled lighting fixture that is used for offices, facilities, and industries may be configured.

The preferred embodiments of the invention are described above. However, the invention is not limited to the embodiments and various design changes can be made in a range that does not depart from the gist of the invention. For example, a lighting fixture of a watertight type having the cover member mounting device or a base-attached lamp including a base member of a GX53 type may be configured.

In this embodiment, the cover member where the screw portion is formed in the inner circumferential surface and the body where the body-side screw portion screwed into the screw portion of the cover member is formed in the outer circumferential surface are used. However, the screw portion may be provided in the outer circumferential surface of the cover member and the body-side screw portion screwed into the screw portion of the cover member may be formed in the inner circumferential surface of the body. If the function of the screw portion is not degraded, the screw portion may be provided in any place of the body side and the cover portion side.

In this embodiment, the cover member uses the circular tray shape having the opening in one end to constitute the globe of the base-attached lamp. However, if the screw portion can be formed, the shape of the cover member may be a flat shape or a shape obtained by combining plural curved surfaces and flat surfaces. The opening has the circular shape. However, a part of the opening may have the circular shape and the other part may have the elliptical shape and a shape obtained by combining other curved lines and straight lines.

With respect to the rotation stopping member, the concave portion and the convex portion of the rotation stopping member are provided in both of the cover member and the screw portion of the body, in the cover member mounting device according to this embodiment. The concave portion and the convex portion may be configured to face any one of the cover member and the body. The concave portion and the convex portion may be formed to face at least one of the screw portion of the cover member and the body-side screw portion of the body. In the engagement of the concave portion and the convex portion, a gap may be formed.

In addition, the unevenness portion is provided by cutting the screw thread of the screw portion. However, other locking members that include an engagement portion and an engagement receiving portion where rotation of the screw in a reverse direction can be locked at the time of rotation of the predetermined amount may be configured.

For example, the engagement potions which engage each other may be formed by making the screw thread thicker (higher).

The packing is configured using the O ring, the O ring is made of the silicone resin or the synthetic rubber, and the O ring is disposed in the space portion that is formed by making the step portion of the cover member and the body-side step portion face each other and has the cross-section to be approximately rectangular. However, the packing according to the first embodiment may be substituted by an elastic member having the restorative force at the time of compression, for example, a spring and a plate spring made of metal or an air cushion.

While certain embodiments have been described, these embodiments have been presented by way of example only, and are not intended to limit the scope of the inventions. Indeed, the novel methods and systems described herein may be embodied in a variety of the other forms; furthermore, various omissions, substitutions and changes in the form of the methods and systems described herein may be made without departing from the sprit of the inventions. The accompanying claims and their equivalents are intended to cover such forms or modifications as would fall within the scope and spirit of the inventions.

What is claimed is:

1. A cover member mounting device comprising:
a cover member that forms a shape having an opening in one end and has a screw portion formed near the opening;
a body that has an opening portion formed at the side of one end and has a body-side screw portion screwed into the screw portion of the cover member and formed near the opening portion;
an elastic member that is interposed between the opening of the cover member and the opening portion of the body; and
a rotation stopping member that has an engagement portion and an engagement receiving portion formed to face at least one of the screw portion of the cover member and the body-side screw portion of the body,
wherein the engagement portion and the engagement receiving portion of the rotation stopping member are engaged by the reactive force generated when the elastic member is deformed by screwing the cover member into the body.

2. The cover member mounting device according to claim 1,
wherein the cover member forms a circular tray shape that has the opening in one end and the screw portion is formed in an inner circumferential surface of the opening.

3. The cover member mounting device according to claim 2,
wherein the body has the opening portion at the side of one end. and the body-side screw portion that is screwed into the screw portion of the cover member is formed in an outer circumferential surface of the opening portion.

4. The cover member mounting device according to claim 1,
wherein the elastic member is a packing that is interposed between the opening of the cover member and the opening portion of the body and the rotation stopping member is engaged by the reactive force generated when the packing is compressed by screwing the cover member into the body.

5. The cover member mounting device according to claim 1,
wherein the rotation stopping member includes a concave portion and a convex portion that are formed to face at least one of the screw portion of the cover member and the body-side screw portion of the body.

6. The cover member mounting device according to claim 5,
wherein the rotation stopping member includes the concave portion and the convex portion that are formed in both of the cover member and the body, the concave portion of the cover member is a portion where a top surface of a screw thread of the screw portion is cut, the convex portion of the cover member is a portion where the top surface of the screw thread is not cut, the concave portion of the body is a portion where a bottom surface of a screw thread of the body-side screw portion is cut, and the convex portion of the body is a portion where the top surface of the screw thread is not cut.

7. The cover member mounting device according to claim 6,
wherein, when the screw portion of the cover member and the body-side screw portion of the body are aligned and screwed, the concave portion where the top surface of the screw thread of the screw portion of the cover member is cut and the concave portion where the bottom surface of the screw thread of the body-side screw portion of the body is cut overlap and are fitted, and the remaining portion where the top surface of the screw thread of the cover member is not cut and the remaining portion where the top surface of the screw thread of the body is not cut are engaged and rotation is stopped.

8. The cover member mounting device according to claim 5,
wherein, when the screw portion of the cover member and the body-side screw portion of the body are screwed, the cover member is moved by the reactive force of the elastic member by the deformation of the elastic member, and the concave portion and the convex portion of the rotation stopping member are engaged.

9. The cover member mounting device according to claim 4,
wherein the cover member has a step portion that is continuous to the screw portion and leads to an opening end,
the body has a body-side step portion that is formed to be continuous to the body-side screw portion and face the step portion of the cover member, and
a space portion that is formed by making the step portion of the cover member and the body-side step portion of the body face each other and has a cross-section to be approximately rectangular is formed, and the packing that is disposed in the space portion is compressed by each inner wall of the space portion by screwing the cover member into the body.

10. A base-attached lamp comprising:
a cover member that has an opening in one end, has a screw portion formed near the opening, has a cover-side step portion continuous to the screw portion and leading to an opening end, and has a light transmitting property;
a body that has an opening portion formed at the side of one end, a body-side screw portion screwed into the screw portion of the cover member and formed near the opening portion, and a body-side step portion formed to be continuous to the body-side screw portion and face the cover-side step portion;
a packing that is disposed in a space portion that is formed by making the cover-side step portion and the body-side step portion face each other and has a cross-section to be approximately rectangular;
a light emitting unit that is disposed in the body to face the cover member; and
a base member that is provided at the side of the other end of the body,
wherein the packing is compressed by each inner wall of the space portion by screwing the cover member into the body.

11. The base-attached lamp according to claim 10,
wherein the cover member forms a circular tray shape that has the opening in one end and the screw portion is formed in an inner circumferential surface of the opening.

12. The base-attached lamp according to claim 11,
wherein the body includes the body-side screw portion that is formed in an outer circumferential surface of the opening portion so as to be screwed into the screw portion of the cover member.

13. The base-attached lamp according to claim 10, further comprising:
a rotation stopping member that includes a concave portion and a convex portion formed to face at least one of the screw portion of the cover member and the body-side screw portion of the body,
wherein the rotation stopping member is engaged by the reactive force generated when the packing is compressed by screwing the cover member into the body.

14. The base-attached lamp according to claim 10,
wherein screwing of the cover member and the body is stopped by a contact of a horizontal surface extended from the cover-side step portion, and a regulation step portion provided in the body.

15. A lighting fixture comprising:
a cover member that forms a shape having an opening in one end and has a screw portion formed near the opening;
a cover member mounting device that includes a body having an opening portion formed at the side of one end and having a body-side screw portion screwed into the screw portion of the cover member and formed near the opening portion, an elastic member interposed between the opening of the cover member and the opening portion of the body, and a rotation stopping member including an engagement portion and an engagement receiving portion formed to face at least one of the screw portion of the cover member and the body-side screw portion of the body, in which the engagement portion and the engagement receiving portion of the rotation stopping member are engaged by the reactive force generated when the elastic member is deformed by screwing the cover member into the body; and
a light emitting unit that is stored in the body to face the cover member,
wherein the cover member has a light transmitting property, light that is emitted from the light emitting unit illuminates one end of the body through the opening, and the cover member and the body are mounted by the cover member mounting device.

16. The lighting fixture according to claim 15,
wherein the cover member has a step portion that is continuous to the screw portion and leads to an opening end,
the body has a body-side step portion that is formed to be continuous to the body-side screw portion and face the step portion of the cover member,
the elastic member is a packing that is disposed in a space portion that is formed by making the cover-side step portion and the body-side step portion face each other and has a cross-section to be approximately rectangular, and
the packing that is disposed in the space portion is compressed by an inner wall of the space portion by screwing the cover member into the body.

17. The lighting fixture according to claim 15,
wherein the rotation stopping member includes a concave portion and a convex portion that are formed to face at least one of the screw portion of the cover member and the body-side screw portion of the body.
